(19) United States
(12) Patent Application Publication
(10) Pub. No.: US 2011/0026687 A1
(43) Pub. Date: Feb. 3, 2011

(54) EMERGENCY 911 SERVICES WITH JUST-IN-TIME PROVISIONING FOR VOIP CUSTOMERS

(76) Inventor: Vladimir SMELYANSKY, Glenview, IL (US)

Correspondence Address: Hanify & King Professional Corporation, 1055 Thomas Jefferson Street, NW, Suite 400, WASHINGTON, DC, 20007, US

(21) Appl. No.: 12/533,827

(22) Filed: Jul. 31, 2009

(51) Int. Cl. H04M 11/04; H04L 12/66

(52) U.S. Cl. 379/45; 370/352

(57) ABSTRACT

A method enables VOIP customers to obtain emergency E911 services from a Public Switched Access Point (PSAP) via a service provider. The customer registers a calling device and at least one device location with the service provider for services. An E911 call to the service provider is initiated by the customer without a real telephone number. A signaling message to the service provider includes the customer device name and address. The service provider accesses a local database in which the customer is registered. Using the device name, the service provider identifies the customer account having an associated updated location. An available telephone number is selected by the service provider and associated with the location to create and store a location-telephone number for the customer. The created location-telephone number is just-in-time provisioned in a positioning center, prior to release of the call. After confirmation, the service provider receives an address or telephone number from the positioning center for delivering the call to a proper PSAP.

### 1. FIELD OF THE INVENTION

The present invention relates to methods, systems and program products providing emergency E911 services for telephones that use Voice Over Internet Protocol (VOIP). More particularly, the invention relates to customer originated VOIP E 911 calls without a real telephone number and/or customer location.

### 2. BACKGROUND OF THE INVENTION

Digitally encoded voice communications transmitted over a network using voice over internet protocol (VoIP) may originate anywhere and the associated communication devices are not tied to a customer number or a customer location, whereas communications originating on the Public Switched Telephone Network (PSTN) are tied to a fixed telephone number and location. According to Federal Communications Commission (FCC) instructions, all requests for E911 services require that calls be associated with a telephone number and an address or location. The telephone number allows a Public Safety Answering Point (PSAP) initiating E911 services to call back a caller in the event the caller is disconnected. The location enables the PSAP to direct emergency services to a proper regional PSAP serving the location.

Because VOIP services are portable or can be used from virtually any internet connection anywhere, the location of the caller may not be capable of being determined automatically by a PSAP to initiate E911 services. Currently, each VOIP customer that has a real number must provide the number and location to a VOIP service provider indicating where the services will be first used. The telephone number and location are provisioned by the VOIP service provider in a database. As a customer moves about and changes location, without notifying the service provider of the new location, the service provider may not be able to send a correct telephone number and location to the proper regional PSAP to initiate E911 services for the customer.

One solution for a nomadic VOIP customer seeking E911 services at a location without a real telephone number is to obtain such services from third party 911 providers. Such providers conduct automatic IP phone tracking and maintain a gateway connected to Public Safety Answering Points (PSAPs) nationwide. Emergency calls are delivered to the appropriate PSAP based on the caller's geographic location. A temporary telephone number is supplied by the third party provider from an extensive database due to the nationwide scope of the service. The cost of the service is expensive due to its nationwide scope.

An alternative solution, at less cost, disclosed herein, relies on just-in time provisioning of a temporary telephone number and location for an E911 caller by a service provider in a VOIP positioning service (VPC). The VPC contains facilities for identifying PSAP boundaries and call routing capabilities. The provisioning occurs prior to the release of the E 911 call to a PSAP by the service provider. The VPC confirms the provisioning with the service provider and returns an electronic address or telephone number of a proper PSAP serving the caller or a National Emergency Center (NEC) in the event the call location is not available or the PSAP does not exist. The service provider delivers the E911 call to the proper PSAP or the NEC before the normal answer time of the PSAP or the NEC to an E911 call. The alternative solution allows service providers to maintain smaller databases of local available telephone number in lieu of nationwide telephone number database maintained by third party providers.

### 3. SUMMARY OF THE INVENTION

A method, system and program product enable VOIP customers, without a real telephone number and known location, to obtain E911 services from a proper PSAP via a service provide and a VOIP Positioning Center (VPC).

To obtain such service, the customer registers a calling device with the service provider for E911 services. The device registration includes customer location and telephone number(s) for at least one geographical location. The registration is updated by the customer as changes occur in location and telephone number. The calling device is associated with a customer account maintained by the service provider. The account specifies unique customer credentials, including at least on one location and telephone number for the calling device.

An E911 call to a service provider is initiated by the VOIP customer, without a real telephone number or known location over network via voice over Internet protocol (VOIP). In one embodiment, the calling device relies upon Session Initiation Protocol (SP) for signaling in conducting the call. However, other signaling alternatives are available for obtaining E911 services A SIP request message to the service provider is generated by the customer via a calling device. The request message includes a header, containing at least a unique SIP Device name, a SIPS URL and a Call-ID, the customer's network address and a message.

The service provider accesses a local database in which the customer is registered and using the SIP Device name in the SIP message identifies the customer account and an associated updated location address for the customer.

The service provider maintains and accesses a database of available telephone numbers for calling purposes. An available telephone number is selected by the service provider for temporary use and associated with the updated address or location of the identified customer account to create and store in a local database a created location-telephone number combination for the customer or caller.

The created location-telephone number is transmitted to the VPC for just-in-time provisioning in a positioning database, prior to the release of the E911 call to a PSAP by the service provider.

The VPC signals the service provider and confirms the provisioning of the created location-telephone number in its database. The VPC also provides an address or telephone number for a proper PSAP or a National Emergency Center (NEC) in the event the call location is not available or the PSAP does not exist for the caller. After confirmation and the call address or telephone number, the service provider delivers the E911 call to the proper PSAP or NEC, as the case maybe.

The invention will be more readily understood from the following Description of a Preferred Embodiment taken in conjunction with an appended Drawing, in which:

### 4. DESCRIPTION OF THE DRAWINGS

FIG. 1 is a system diagram providing E911 services via just-in- time provisioning of a VPC in servicing an E911 call without a real telephone number, according to an embodiment of the invention;

FIG. 2A is a representation of Session Initiation Protocol (SIS) Request and Response messages.

FIG. 2B is a line diagram representing SIP messaging between a VOIP customer and a Service Provider for emergency services; and

FIG. 3 is a flow diagram of a process implemented in FIG. 1 providing E911 services via just-in-time provisioning of a VPC in servicing an E911 call to a proper PSAP or a National Emergency Center (NEC).

### 5. DESCRIPTION OF PREFERRED EMBODIMENT

The present application provides enhanced E911 services for Voice-Over Internet (VOIP) customers, particularly where the customer travels to another location and has no real telephone number at the new location. Enhanced E911 services require a physical address with a calling party's telephone number to route the call to an appropriate Public Safety Answering Point (PSAP) for that call and address. The PSAP routes the call to an emergency responder providing emergency services. A caller's address and location information enables the emergency responders to provide service without the customer calling for help providing the information.

VOIP converts voice into digital signals which travel over the internet. VOIP is described in the text “Voice Over IP Fundamentals” by Jonathan Davidson and James Peters, published by Cisco Press, Indianapolis, Ind., 2000, ISBN: 1-57870-168-6. When a regular phone number is called, a digital signal is converted into a regular telephone signal before reaching the destination. VOIP can allow a call directly from a computer, a VOIP phone or traditional phone connected to a special adapter. Wireless locations at airports, parks and cafes allow connection to the Internet to use VOIP services wirelessly.

The basic steps involved in originating an Internet telephone call are conversion of the analog voice into digital format; compression/translation of a signal into Internet Protocol Practice for transmission over the Internet. The process is reversed at the receiving end.

VOIP systems employ various signaling protocols Session Initiated Protocol (SI); Skype (a software application available from EBay that allows users to make voice calls over the Internet); Google Talk (A Windows and web-based application for instant messaging and voice over internet protocol (VOIP), offered by Google Inc The signaling protocols may be used to control the setup and teardown of calls, as well as audio decompression, which includes the audio allowing transmission over an IP network as digital audio via a digital stream. Decompression used is varied among the different implementations on VOIP. Some implementations rely on narrow band and compressed speech, while others support high fidelity stereo codes. The benefits of VOIP are operational costs and flexibility.

The present application will be described in terms of (1) a representative system for implementing E911 services on a VOIP system; (2) SIP signaling between a customer and a service provider relating to a customer request for E911 services; and (3) a representative process implementing a customer request for E911 services, where the customer has traveled to a new location and is without a real telephone number or known location.

1. A VOIP System Implementing E911 Requests for Customers Without a Telephone Number or Location:

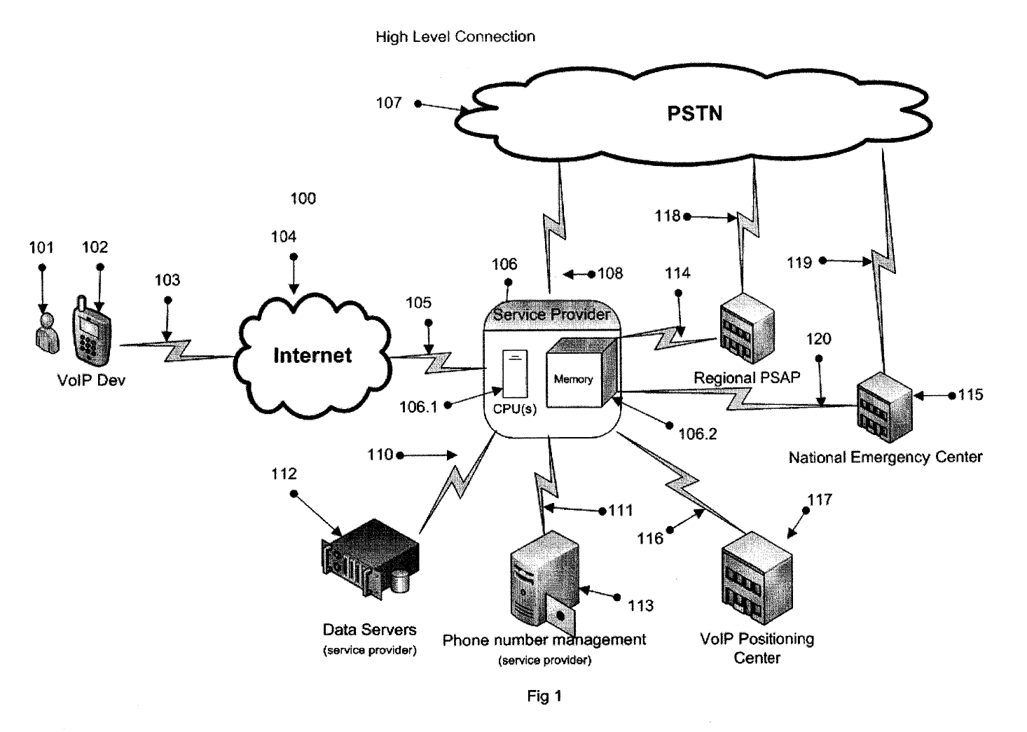

FIG. 1 discloses a VOIP System 100 providing E911 services for a customer 101 over a VOIP Device 102, where the customer 101 has traveled to another location and is without a real telephone number or known location. The VOIP device may be an IP phone using VOIP technologies to allow telephone calls to travel over an IP network. IP phones can be hardware built devices and appear like an ordinary telephone or a cordless phone. They may also exist as a standard telephone with an analog telephone adapter. A cell phone may be used for making telephone calls over the Internet using a general purpose computer rather than using dedicated hardware. The device 102 may also be a softphone executing a program running on a computer.

The Device 102 is linked to a distributed information network, typically the Internet 104 via a communication path 103 receiving data and signaling, where the signaling may be SIP, Skype, Google Talk and the like. The network 104 is linked to a service provider 106 via communication path 105.

The service provider includes a processor 106.1 and a memory 106.2. The processor executes stored programs in the memory for packet data transmission and accompanying signaling in receiving and responding to customer requests for services. The memory may be Random Access Memory (RAM), Read Only Memory (ROM) and the like, storing the programs for operating the processor.

A data server 112 is linked to the service provider via a communication path 110. The data server stores customer account information for each customer served by the service provider. The customer account information describes at least one and typically several alternative locations and associated phone numbers enabling the customer to originate calls to the service provider for services. The service provider requires the customer to update customer account information prior to receiving services from any device 102 location, not listed in the account.

A phone number management device 113 is linked to the service provider via communication path 111. The device 113 contains available telephone number, which the service provider may assign to a customer in a new location and without a real telephone number for the new location. An assigned available phone numbers can be obtained from the geographical area that corresponds to the caller area code. The quantity of available number in the device 113 is typically small, due to the limited area served by the service provider. The selected telephone number is a temporary number reserved by the service provider to a customer for a limited amount of time after an E911 call is processed by an emergency center. The number of available telephone number in the device 113 is relatively small due to the small geographical area serviced by the service provider. In contrast, third party providers and others maintain a significantly larger number of telephone numbers due to servicing a nationwide area.

A VOIP positioning center (VPC) 117 provides 911 operations support systems for servicing service providers and others. Several private companies provide such services, including Intrado, located at Longmont, Colo.; TeleCommunications Systems, Annapolis, Md. The support services include provisioning of subscriber records; PSAP boundaries; assignment of appropriate 911 call routing and related services for service providers and other.

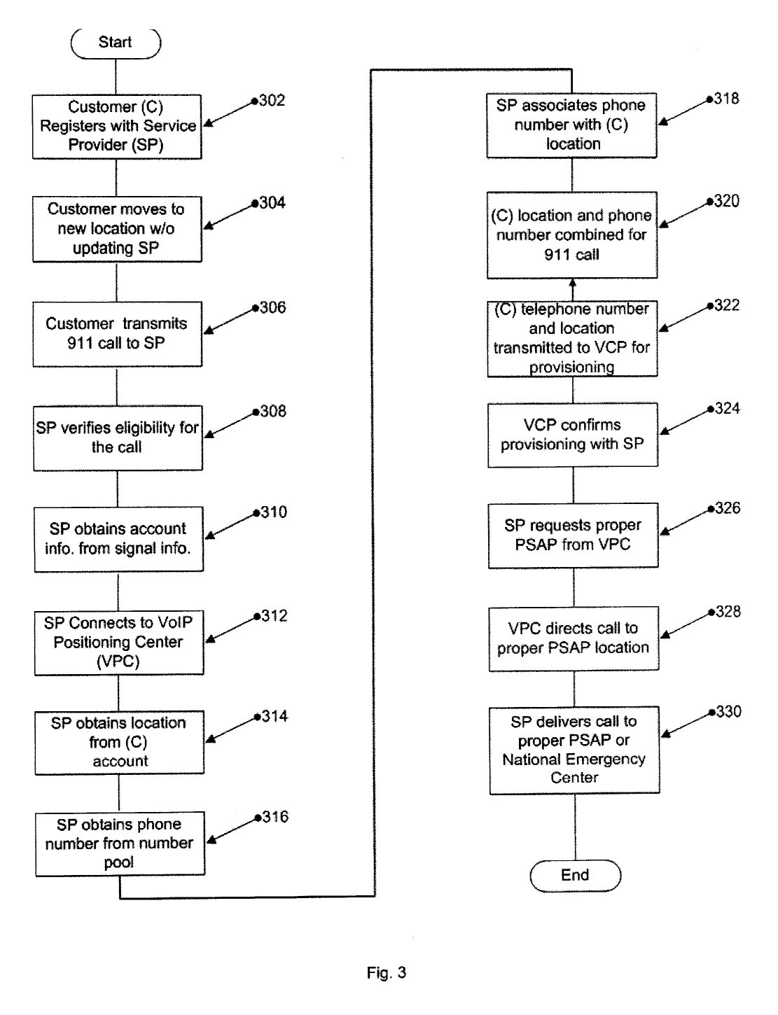

The center 117 is linked to the service provider via a communication path 116. The center processes, stores and translated customer created location-phone numbers received from the service provider to an address or telephone number for a proper regional PSAP servicing an E911 call or a National Emergency Center (NEC) call, as will be further described, hereinafter, in connection with the description of FIG. 3. A NEC is a command center established and maintained by the Federal Government on a 24/7 basis for assisting first responders in emergency matters. Further details are described in Federal legislation introduced Jan. 22, 2009 in House of Representative Bill HR 645, available on the search engine Google.

E911 calls are delivered to a regional PSAP 115 or a NEC 118 by the VPC, after the service provider checks the credentials of the call for location and telephone number in the data server. Calls having location and telephone number are delivered to a PSAP for response to the emergency.

Calls without a real telephone and location are processed by the processor to create a “location-available telephone number” for just-in-time provisioning in the positioning center 117 The positioning center confirms the provisioning with the service provider and returns an address or telephone number enabling the service provider to deliver the call to the proper PSAP for response to the emergency call. The “location—available telephone number” enables the PSAP or emergency service to communicate with the caller via the telephone and deliver any necessary services to the caller's location.

Both the service provider 116 and the PSAP 115 are linked to a Public Switched Telephone Network 107 or other wireline or wireless public communication networks serving service provider customers via communication paths 108 and 118, respectively. The network allows the PSAP to communicate with the call device 102 via the service provider providing the call device telephone number.

The National Emergency Center 118 operated by the Federal Government or an Enhanced 911 services operated by private companies are coupled to the service provider via communication link 120 for processing calls without location information or in the event the caller is not covered by a PSAP.

A further description of the operation of System 100 will described in FIG. 3, after a description of the signaling process implemented between the VOIP device 102 and the service provider 106.

2. Session Initiated Protocol (SIP) Implemented Between a VOIP Device and a Service Provider for E911 Services:

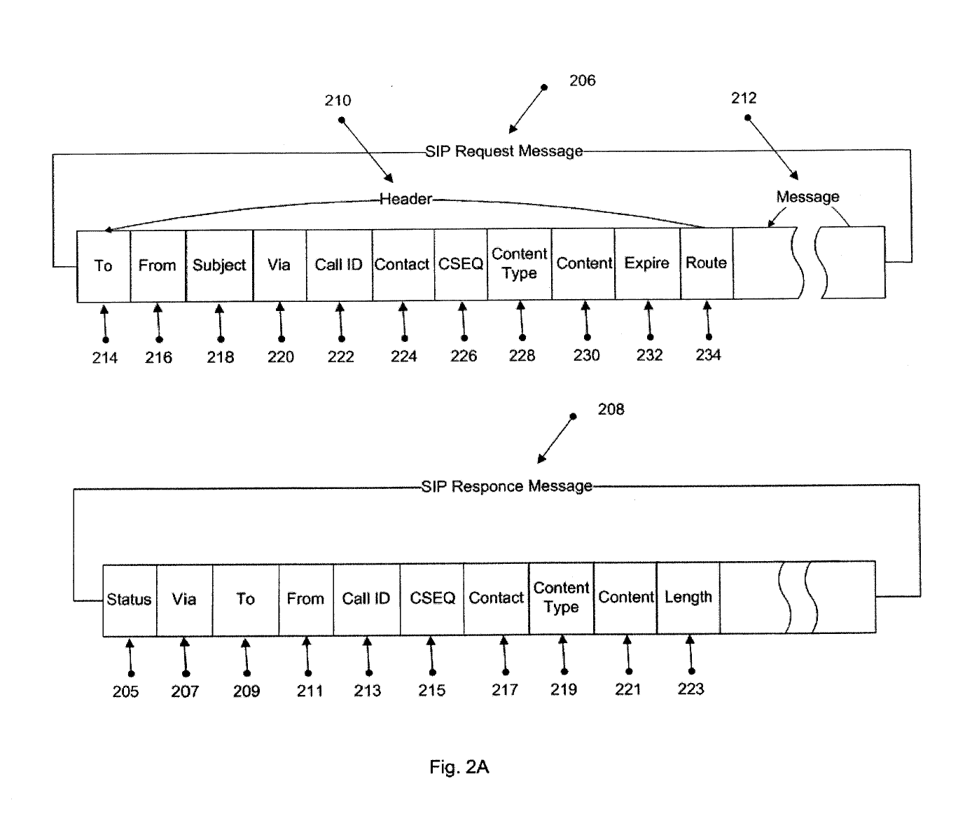

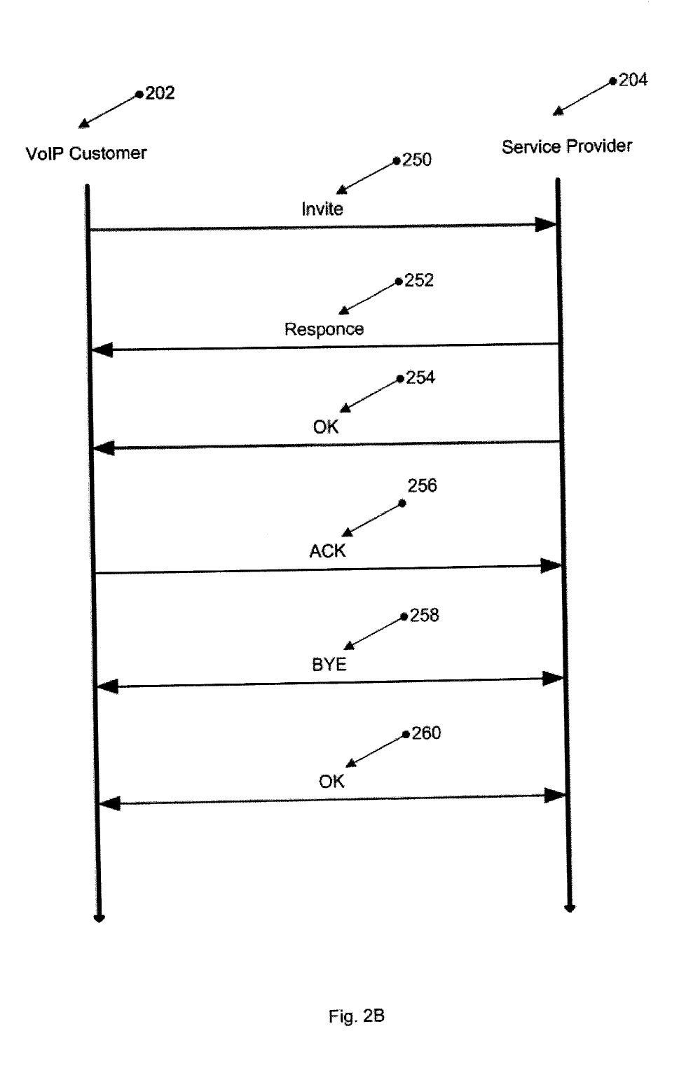

FIGS. 2A and 2B disclose SIP messaging and process for a VOIP customer 202 interacting with a service provider 204. SIP is a signaling protocol described in Internet Engineering Task Force Standard (IETF) (RFC 3261). SIP is used to create, manage and terminate communication sessions between Users in an IP based network. A session may be a simple two-way telephone call or a collaborative, multimedia conference session.

While SIP signaling will be described in implementing E911 calls for a VOIP customer or user, without a real telephone number, other signaling protocols are available for the signaling process, including Skype, Google Talk and others.

A brief description of the SIP commands and message formats is believed appropriate for better understanding of handling caller requests for E911 services without a real telephone number associated with the request.

The SIP commands used in the signaling process include:
INVITE: Invites a user to a call.
ACK: Acknowledgment is used to facilitate reliable message exchange for Invites.
BYE: Terminates a connection between users.
CANCEL: Terminates a request or a search for a user. The command is used if a client sends an INVITE then changes its decision to call the recipient.
OPTIONS: Solicits information about a server's capability.

FIG. 2A describes message formats 206 and 208. The message format 206 is used by a customer or user to request services from a service provider. The message format 208 describes a service provider's response message to the customer or user.

The request message 206 includes a header portion 210 and a message portion 212. A field “To” 214 contains a display name “User 2” for the service provider and a SIP's URL address “User2@server2.com.” A “From” field 216 contains a display name “User 1” for the VOIP customer and a SIP's URL address “User1@server1.com.” A message subject field 218 may also be included. A “Via” field 220 contains the local address of User 1, or the VOIP customer, where it is expected the service provider's response is to come. A call ID field 222 is a globally unique identifier of the call and includes the phone web address. A “Contact” field 224 contains a SIP's URL that is a direct route to the User 1. The field contains the user name and a fully-qualified domain. It may also have an IP address. A “C-Sequence SEQ” field 226 contains an integer and a message name. When a transaction starts, the first message is given a random C-SEQ and after that, incremented by one with each new message. It is used to detect non-delivery of a message or out of order delivery of messages. A content-type field 228 contains a description of the message body. A “Content” field 230 is a byte count of the message body. An “Expiration” field 232 indicates the date the message expires. A “Route” field 234 describes a message routing path. The message is contained in the field 236.

The response message format 208 contains a “Status” field 205 displaying a status code indicating six categories of responses, which are similar to those of Hypertext Transfer Protocol (HTTP). The categories include provisional; success; redirection; client error; server error and global failure. Each category has a distinct code in a hundreds series, i.e. 100, 200 . . . 600. The header fields that follow the status field are similar to those in the request message 206 and are believed not to require any further description, except to indicate that the message field for both the request message and the response message are written, typically in Session Description Protocol (SDP) described in RSC5159.

Turning to FIG. 2B, a customer or user 202 initiates an invite to the service provider 204 based on the request message 206. The customer or user 202 is identified in the “From” field 216 providing a user name and a current user address. The service provider 204 responds with a response message shown in FIG. 2B and includes a status field for the user's message. The service provider returns a code 200 for success or OK message to the customer or user denoting the user's message was successfully received, understood and accepted. The customer or user returns to the service provider an ACK message 256 to initiate message exchange with the service provider. Messaging between the user and service provider continues until a BYE message 258 is sent by the service provide or customer. The user provider responds with a 200 code or OK message 268 to terminate the connection between the user and the service provider.

3. An Exemplary Process for a Customer Without a Telephone Number or Location Implementing a Request for E911 Services:

FIG. 3 is a flow diagram of a process 300 enabling the customer 101 to obtain E911 services via the VOIP device (102) without a real telephone number or location. FIG. 3 will be described in conjunction with FIGS. 1, 2A and 2B.

In block 302, the customer or user 101 registers with the service provider or a registrar's server and provides a telephone number and current location, along with any alternate telephone number(s) and location(s) where the customer may be present. The service provider establishes a customer account for the customer and stores the account information in a database included in data server 112. The customer is required to update the customer account whenever his location or telephone number changes.

In block 304, the customer travels to a location without providing the location to the service provider and makes an emergency call for E911 services.

In block 306, a 911 call without a real telephone is made over data link 103 connected to a wide area network 104, establishing a connection to the service provider 106 using SIP signaling.

In block 308, the service provider verifies the eligibility of the customer to make a call by checking device 102 credentials in the data server 112.

In block 310, the service provider examines the customer signaling message and identifies the user name and user address or location. The customer location in the data server 112 is updated in the customer account, according to the signaling message.

In block 312, the service provider connects to the VPC 117 for just-in-time provisioning of the call for delivery to a PSAP.

In block 314, the service provider obtains the customer location from the customer account updated via the field 220 in the request message 206.

In block 316, after the customer location is obtained in block 314 the service provider, over communication link 111, acquires an available PSTN phone number for the location from the Phone Number Management Database 113.

In block 318, the service provider temporarily associates the available phone number with the device location taken from the customer account records. The temporary telephone is retained by the service provider for a limited amount of time after completion of the E911 call in the event the PSAP or emergency service provider needs to contact the E911 caller.

In block 320, the phone number obtained from database 113 is combined with the customer location in the data server 112 for use in provisioning the VPC.

In block 322, the service provider over connection 116 provisions the VPC with the location and telephone number of the 911 call, prior to the release of the call to a PSAP.

In block 324, the positioning center (VPC) confirms the provisioning of the customer location and telephone number with the service provider.

In block 326, after confirmation, the service provider receives an address or a telephone number of the proper PSAP from the VPC.

In block 328, the VPC supplies the service provider with the address or telephone number to deliver the E911 call from the device 102 to the proper PSAP.

In block 330, the service provider delivers the E911 call from the device 102 to the proper PSAP within a time period less the actual time period of a PSAP for responding to E911 calls due in part to the limited number of telephone numbers in the management device 113.

In the event the customer location is not known or a particular area is not covered by emergency services, the call is delivered to one of the national emergency centers 118 over link 120. If for any reason the PSAP or emergency service provider needs to call back to E911 caller, the call will go over the PSTN network 121, 107, 108 to service provider 116. The call will be delivered to the caller by the service provider using temporary telephone number assigned to the caller in block 318.

While the invention has been described in a preferred embodiment, various changes and modifications can be made to the method, system and computer program without departing from the spirit and scope of the invention.

What is claimed is:

1. A method, comprising:
registering with a service provider a caller device having a unique caller device name and telephone number for emergency E911 services;
initiating an emergency E911 call by a caller, without a real telephone number, over a network via Voice Over Internet protocol (VOIP) using a signaling protocol that identifies at least the caller device name and address;
accessing a first database maintained by the service provider to identify a customer account corresponding to at least the caller device name and address;
accessing a second database of available telephone number maintained by the service provider for calling purposes;
selecting an available telephone number from the second database for temporary use and associating the selected available telephone number with the location contained in the identified customer account to create a location-telephone number combination for the caller;
storing and transmitting the created location-telephone number for just-in-time provisioning in a positioning center, prior to the release of an E911 call to a Public Switching Access Point (PSAP);
confirming with the service provider the provisioning in the positioning center of the created location-telephone number, and providing an address or telephone number of a proper PSAP for delivery of the E911 call; and
delivering the E911 call from the caller to the proper PSAP by the service provider based on the address or telephone number provided by the positioning center

2. The method of claim 1, further comprising:
selecting a signaling protocol from the group comprising: Session Initiated Protocol (SIP); Skype and Google Talk.

3. The method of claim 1 further comprising:
associating the selected available telephone number with the identified customer account for a limited amount of time after completion of the E911 call.

4. The method of claim 1 further comprising:
coupling the service provider and the PSAP to a pubic communications network via communication links.

5. The method of claim 4 further comprising:
establishing a communication link between the PSAP and the service provider via the communication links.

6. The method of claim 5 further comprising:
sending a message to the caller from the PSAP via the communication links for delivery to the caller by the service provider using the temporary telephone number.

7. The method of claim 1 further comprising:
delivering the call to a National Emergency Center in the event the caller location is not known or an area is not covered by emergency services.

8. The method of claim 1 wherein the network is the Internet.

9. The method of claim 1 wherein the call is delivered to the PSAP by the service provider in less than an answer time of the PSAP responding to E911 calls.

10. The method of claim 1 wherein the caller device is an IP phone or a softphone.

11. A system, comprising:
a service provider including a processor and a memory for registering a caller device having a unique caller device name and telephone number for emergency E911 services;
a communicating device for initiating an emergency E911 call by a caller, without a real telephone number, over a network via Voice Over Internet protocol (VOIP) using a signaling protocol that identifies at least the caller device name and address;
a first database maintained by the service provider including a customer account corresponding to at least the caller device name and location;
a second database of available telephone numbers maintained by the service provider for calling purposes;
the processor selecting an available telephone number from the second database and associating the selected available telephone number with the location contained in the identified customer account to create a location-telephone number combination for the caller; and
a positioning center for just-in-time provisioning of the location—telephone number received via the service provider, and return of an address or telephone number of a proper Public Safety Answering Point (PSAP)to the service provider prior to the delivery of the call by the service provider to the PSAP.

12. The system of claim 11, further comprising:
a signaling protocol selected from the group comprising: Session Initiated Protocol (SIP); Skype and Google Talk.

13. The system of claim 11 further comprising:
the service provider associating the selected available telephone number with the identified customer account for a limited amount of time after completion of the E911 call to the PSAP.

14. The system of claim 11 further comprising:
communication links coupling the service provider and the PSAP to a public communications network.

15. The system of claim 14 further comprising:
a communication path established between the PSAP and the service provider via the communication links.

16. The system of claim 15 further comprising:
a message transmitted from the PSAP to the caller via the service provider using the selected telephone umber.

17. The system of claim 11 further comprising:
a communication link for delivering a call to a National Emergency Center in the event the caller location is not known or an area is not covered by emergency services.

18. The system of claim 11 wherein the network is the Internet.

19. The system of claim 11 wherein the call is released to the PSAP in less than an answer time of the PSAP responding to an E911 call.

20. The system of claim 11 wherein the caller device is an IP phone.

21. a medium containing program instructions, executable in a computer system, for just-in-time delivery of a location-telephone number of a caller for initiating emergency 911 services, comprising:
program instructions for registering with a service provider a caller device having a unique caller device name and telephone number for emergency E911 services;
program instructions for initiating an emergency E911 call by a caller, without a real telephone number, over a network via Voice Over Internet protocol (VOIP) using a signaling protocol that identifies at least the caller device name and address;
program instructions for accessing a first database maintained by the service provider to identify a customer account corresponding to at least the caller device name and address;
program instructions for accessing a second database of available telephone numbers maintained by the service provider for calling purposes;
program instructions for selecting an available telephone number from the second database and associating the selected available telephone number with the location contained in the identified customer account to create a location-telephone number combination for the caller;
program instructions for storing and transmitting the created customer location-telephone number for provisioning in a positioning center;
program instructions for confirming with the service provider the provisioning in the positioning database of the created location-telephone number, and returning an address or telephone umber of a Public Switched Access point (PSAP) to the service provider; and
program instructions for delivering the E911 call from the caller by the service provider to a proper PSAP based on the address or telephone number provided by the positioning center.

22. The medium of claim 21, further comprising:
program instructions for selecting a signaling protocol from the group comprising: Session Initiated Protocol (SIP); Skype and Google Talk.

23. The medium of claim 21 further comprising:
program instructions for associating the selected available telephone number with the identified customer account for a limited amount of time.

24. The medium of claim 21 further comprising:
program instructions for coupling the service provider and the PSAP to a pubic communications network via communication links.

25. The medium of claim 24 further comprising:
program instructions for establishing a communication link between the PSAP and the service provider via the communication links.

26. The medium of claim 25 further comprising:
program instructions for sending a message to the caller from the PSAP via the communication links for delivery to the caller by the service provider using the selected available telephone number.

27. The medium of claim 21 further comprising:
program instructions for delivering the call to a National Emergency Center in the event the caller location is not known or an area is not covered by emergency services.
